(19) United States
(12) Patent Application Publication
(10) Pub. No.: US 2006/0227114 A1
(43) Pub. Date: Oct. 12, 2006

(54) Touch location determination with error correction for sensor movement

(76) Inventors: Bernard O. Geaghan, Salem, NH (US); Bruce A. Lessard, Salem, MA (US)

Correspondence Address: 3M INNOVATIVE PROPERTIES COMPANY, PO BOX 33427, ST. PAUL, MN, 55133-3427, US

(21) Appl. No.: 11/093,895

(22) Filed: Mar. 30, 2005

(51) Int. Cl. G09G 5/00

(52) U.S. Cl. 345/173

(57) ABSTRACT

Touch location determination is enhanced by correcting for errors that arise due to touch panel movement. A touch sensitive device includes a capacitive touch sensor configured to generate signals indicative of a location of a capacitively coupled touch on a touch surface. An error correction sensor generates a signal associated with movement of the capacitive touch sensor. Touch location is determined using the touch location signals and the error signal.

### FIELD OF THE INVENTION

The present invention relates to touch sensitive devices and, more particularly, to methods and systems using a enhancing touch location determination in a capacitive touch sensitive panel.

### BACKGROUND

A touch sensitive device offers a simple, intuitive interface to a computer or other data processing device. Rather than using a keyboard to type in data, a user can transfer information by touching an icon or by writing or drawing on a touch sensitive panel. Touch panels are used in a variety of information processing applications. Interactive visual displays often include some form of touch sensitive panel. Integrating touch sensitive panels with visual displays is becoming more common with the emergence of next generation portable multimedia devices such as cell phones, personal data assistants (PDAs), and handheld or laptop computers.

Various touch panels use capacitive sensing techniques to determine the touch location on a touch sensitive surface. Capacitive systems determine touch location based on capacitive coupling caused by the touch on or near the touch surface. One type of capacitive touch panel typically includes a resistive layer deposited on a substrate. The resistive layer forms the touch surface of the touch panel. An electrical signal is applied to the resistive layer at several locations, for example, at each of the touch panel corners, creating a uniform field across the touch surface. When a user's finger approaches or comes into contact with the touch surface, a signal is capacitively coupled through the user's finger to the touch surface. In this configuration, the resistive layer forms one plate of a capacitor and the other capacitive plate is formed by the user's finger. The capacitive coupling alters the signal current flowing from each corner. Controller circuits measure the changes in currents at each corner caused by the change in capacitance. The controller circuits determine the touch location based on the relative magnitudes of the corner currents.

In another type of capacitive touch panel, a matrix or grid of electrically conductive metallic or ceramic electrodes is disposed on either side of a dielectric layer. AC signals are applied to each electrode, and at least one signal parameter, for example the voltage and/or current, of each applied signal is measured. A user's finger on or near the touch panel will capacitively couple to the electrodes in the panel, causing a change in a signal parameter of one or more electrodes. The signals at the electrodes are measured and the changes of signal parameters of each electrode are determined. Relative changes of signal parameters among the electrodes are analyzed to determine the touch location. Interpolation may be used to determine a touch location between electrodes.

### SUMMARY OF THE INVENTION

The present invention is directed to methods and systems for enhancing touch location determination by correcting for errors due to touch panel movement.

One embodiment of the invention is directed to a touch sensitive device. The touch sensitive device includes a capacitive touch sensor configured to generate signals indicative of a location of a capacitively coupled touch on a touch surface. An error correction sensor generates a signal associated with an error in the touch location signals. The error is associated with movement of the capacitive touch sensor. The touch sensitive device includes a processor configured to determine the touch location based on the touch location signals and the error signal.

In various implementations, the error correction sensor may include a capacitive sensor, force sensor, bending mode sensor, or other type of sensor configured to detect errors caused by touch panel movement.

The capacitive touch sensor used for touch location determination may include an electrode layer disposed on one side of a substrate. The error correction sensor may include one or more electrodes disposed on an opposite side of the substrate. In one configuration, the error correction sensor may include a continuous electrode disposed on a peripheral portion of the substrate. In another configuration, the error correction sensor may include a plurality of discrete electrodes disposed on a peripheral portion of the substrate.

The electrode(s) of the error correction sensor may be used to shield portions of the electrode layer from electrode magnetic interference (EMI). Additionally, or alternatively, the electrode(s) of the error correction sensor may be configured to reduce capacitive coupling between the electrode layer and conductive structures of the touch sensitive device. In addition to providing error correction and/or shielding capabilities, the error correction sensor may be further configured to measure the force of the touch on the touch surface.

Another embodiment of the invention involves a method for determining a location of a touch on a touch surface. Touch signals from a capacitively coupled touch on the touch surface are generated. An error signal associated with movement of the touch surface is generated. The touch location is determined based on the touch signals and the error signal.

In one implementation, the error signal is generated by measuring a change in capacitance responsive to movement of the touch sensor that is used to generate the touch signals. Other implementations involve measuring the displacement or low frequency oscillations of the touch surface. The touch location may be determined by adjusting the touch signals based on the error signal.

According to various aspects of the invention, the error signal may be used to calibrate the touch surface and/or to determine the force of the touch.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIGS. 1A and 1B are flowcharts illustrating a touch sensing method in accordance with embodiments of the invention;

FIG. 2 is a block diagram showing a touch panel system that includes a capacitive touch sensor electrically coupled to a controller in accordance with embodiments of the invention;

FIG. 3 is a diagram of a touch panel having a single rear electrode configured in accordance with embodiments of the invention;

FIG. 4 is a diagram of a capacitive touch panel having multiple rear electrodes configured in accordance with embodiments of the invention;

FIGS. 5A and 5B are diagrams illustrating a cross section of a touch panel system having rear electrodes in accordance with embodiments of the invention;

FIGS. 5C and 5D are diagrams illustrating a cross section of touch panel system using one or more force sensors for error correction in accordance with embodiments of the invention;

FIGS. 5E and 5F are diagrams illustrating a cross section of a touch panel system using one or more bending mode sensors for error correction in accordance with embodiments of the invention;

FIGS. 6-8 illustrate various types of capacitive touch panels that may utilize error correction processes in accordance with embodiments of the invention; and

FIG. 9 is a block diagram of a touch screen system suitable for implementing enhanced touch location determination in accordance with embodiments of the invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings that form a part hereof, and in which is shown by way of illustration, various embodiments in which the invention may be practiced. It is to be understood that the embodiments may be utilized and structural changes may be made without departing from the scope of the present invention.

The pressure of a touch on a capacitive touch panel may cause movement of the capacitive sensor relative to its environment, including nearby conductive objects such as the display and/or chassis. The movement of the touch panel causes a change in capacitive current that may cause errors in the measured location of the valid touch. This phenomenon is particularly prevalent for larger touch panels, e.g., greater than about 20 inches diagonal, because large panels have greater parasitic capacitance and bend more than small ones. The combination of greater parasitic capacitance and increased bending causes larger changes in parasitic capacitance with touch pressure for large touch panels. A grounded or driven rear shield helps to reduce the parasitic capacitance and capacitive changes associated with touch panel movement.

Many capacitive touch screens use a transparent rear shield that provides several beneficial effects. A grounded or driven rear shield blocks changes in parasitic capacitive coupling to the nearby display or chassis when the touch screen moves under touch pressure. A driven shield minimizes capacitive coupling of the touch surface to a nearby display or chassis. In addition, the rear shield blocks EMI coming from behind the touch panel, such as EMI emanating from a display device.

Despite the benefits of the rear shield, the additional shield layer increases the cost of the touch panel and reduces the optical transmission through transparent touch panels. Embodiments of the invention involve a capacitive touch panel without a rear shield. The capacitive touch system of the present invention provides some of the benefits of a rear shield listed above without the associated consequences of expense and loss of optical transmission.

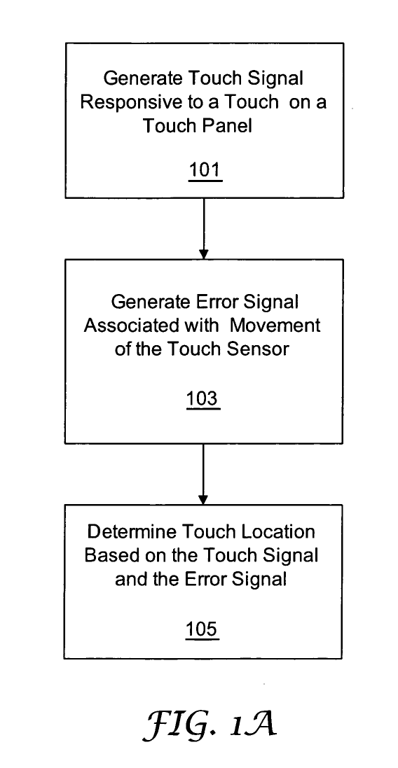

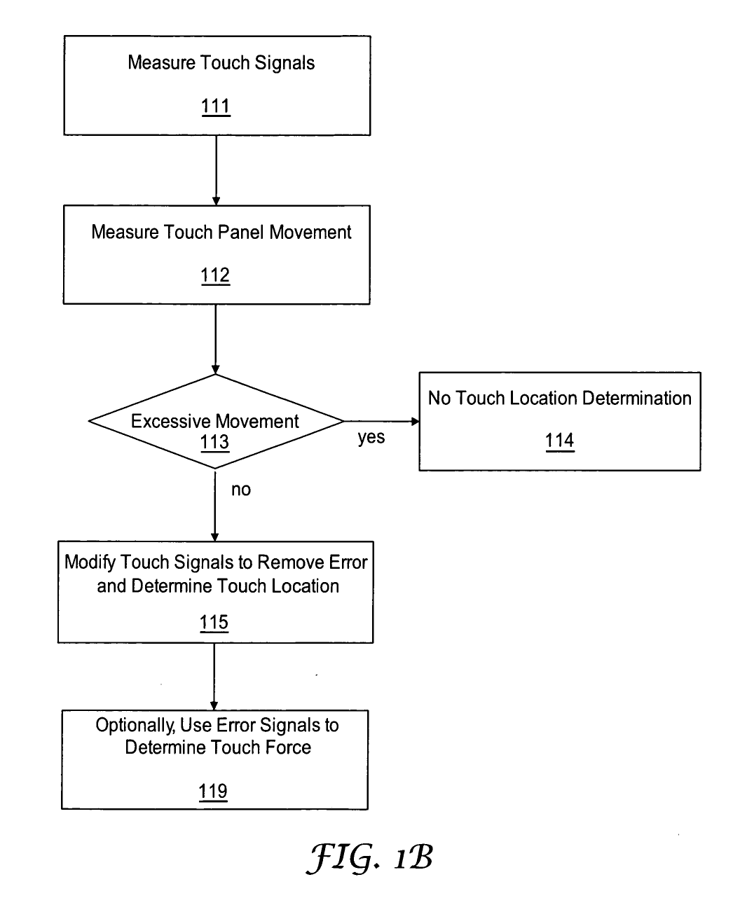

Embodiments of the invention are directed to methods and systems for error correction and EMI shielding in touch panel systems that do not use a rear shield. An additional sensor or sensors are employed to correct for errors in touch location determination caused by changes in parasitic capacitance due to touch panel movement. FIG. 1A is a flowchart illustrating a touch sensing method in accordance with embodiments of the invention. According to this method, touch signals indicative of a capacitively coupled touch on a touch panel are generated 101. An error signal associated with an error in the touch signal is generated 103. The error signal is related to the movement of the capacitive touch panel due to the touch pressure. Movement of the touch panel may include, for example, displacement of the touch panel, bending, flexing and/or torsion of the touch panel and/or any other change in the physical orientation of the touch panel with respect to one or more nearby structures. The touch location is determined 105 based on the touch signals and the error signal.

In one implementation, the error signal may be generated based on a change in current due to a changing capacitance caused by movement of the touch panel. As described herein, such an error signal may be generated using rear electrodes disposed on a capacitive touch panel. In other configurations, the error signal may be generated by a force sensor, accelerometer, bending mode sensor or any other type of sensor configured to sense a parameter indicative of touch panel movement. In some embodiments, the error signal may be used to measure the force of the touch on the touch panel surface.

FIG. 1B is a flowchart illustrating a method for enhancing touch location determination in accordance with embodiments of the invention. Touch signals are measured 111 at one or more electrodes of a touch panel, for example, electrodes positioned at each of the corners of a rectangular touch panel. Movement of the touch panel due to touch pressure may cause touch signal measurement errors. In some implementations, movement of the touch panel may be measured 112 separately from touch signals, and the known amount of movement can be used to estimate the touch signal measurement errors. Estimated errors can then be used to modify 115 touch signals to remove the errors, or to avoid 114 making measurements when sensor movement errors are too large 113. In other implementations, signals generated by the error sensors may be used correct for errors caused by movement of the touch panel without measuring the amount of movement. Optionally, the error signals may also be used to determine 119 the Z-axis force of the touch on the touch panel.

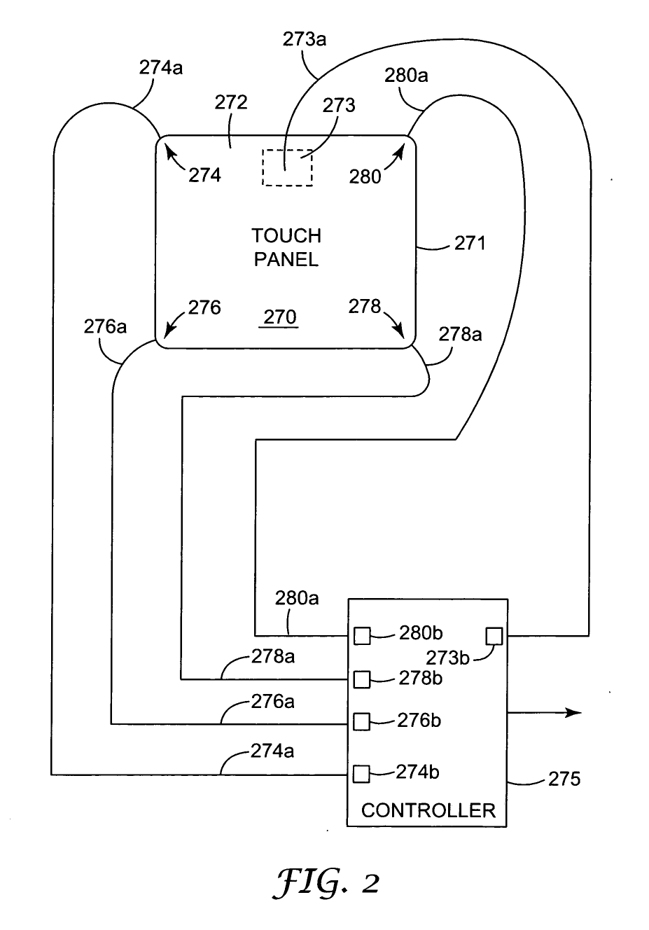

In FIG. 2, there is shown a touch screen system that includes a capacitive touch panel 270 electrically coupled to a controller 275 in accordance with an embodiment of the present invention. The capacitive touch panel 270 illustrated in FIG. 2 may be used in connection with touch location detection with error correction in accordance with embodiments of the invention. The touch panel 270 includes a substrate, such as glass, which has top and rear surfaces 272, 271 respectively provided with an electrically conductive coating. The top surface 272 is the primary surface for sensing touch. The top surface 272 is nominally driven with an AC voltage in the range of about 1 V to about 5 V.

The touch panel 270 is shown to include four corner terminals 274, 276, 278, 280 to which respective wires 274a, 276a, 278a, 280a are attached. Each of the wires 274a, 276a, 278a, 280a is coupled to the controller 275. The wires 274a, 276a, 278a, 280a connect their respective corner terminals 274, 276, 278, 280 to respective drive/sense circuits 274b, 276b, 278b, 280b provided in the controller 275.

The touch screen system also includes at least one wire 273a coupled at least one error sensor 273. In one embodiment, the error sensor 273 comprises a capacitive sensor that generates a signal based on a change in capacitance caused by movement of the touch surface due to touch pressure. The error sensor 273 is coupled by the wire 273a to an error sensor drive/sense circuit 273b in controller 275.

The controller 275 controls the voltage at each of the corner terminals 274, 276, 278, 280 via drive/sense circuits 274b, 276b, 278b, 280b to maintain a desired voltage on the top surface 272. A finger or stylus touch force applied to the top surface 272 is detected as an effective small capacitor applied to the top surface 272. The touch produces a change in current flow measurements made by the controller 275 via corner drive/sense circuits 274b, 276b, 278b, 280b. The controller 275 measures the changes in currents at each corner terminal 274, 276, 278, 280 caused by the change in capacitance and determines the touch location based on the relative magnitudes of the corner currents, typically using Equations 1 and 2 below.
XT=(UR+LR−UL−LL)/(UR+LR+UL+LL) Equation 1
YT=(UR+UL−LR−LL)/(UR+LR+UL+LL) Equation 2
where UL, LL, LR, UR are currents measured at the upper left, lower left, lower right, upper right corner terminals 274, 276, 278, 280, respectively.

The error sensor 273 generates an error signal based on the movement of the touch sensor 270 with respect to surrounding conductive structures due to the touch pressure. The controller 275 determines the touch location based on the change in current flow measurements made by the controller 275 via corner drive/sense circuits 274b, 276b, 278b, 280b and the change in the error signal measurement made by the controller via the error drive/sense circuit 273b.

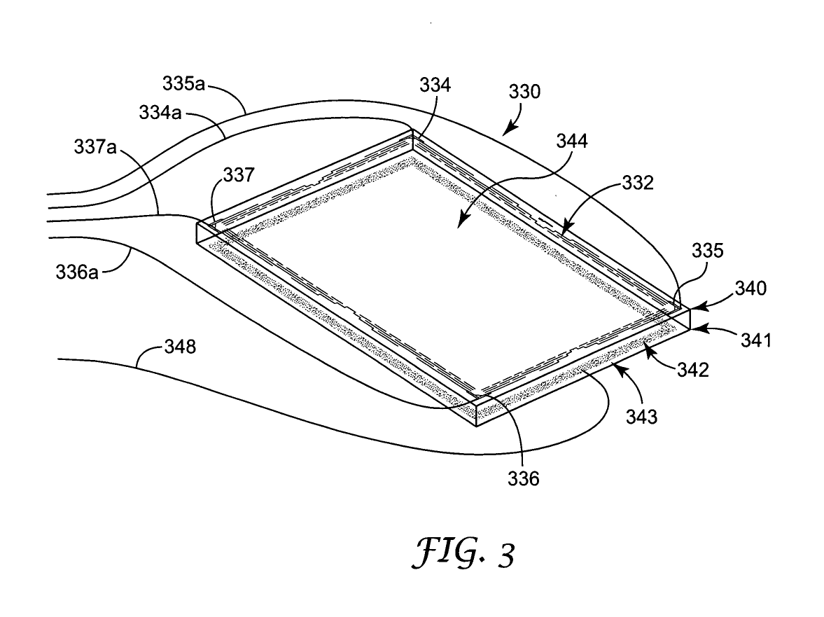

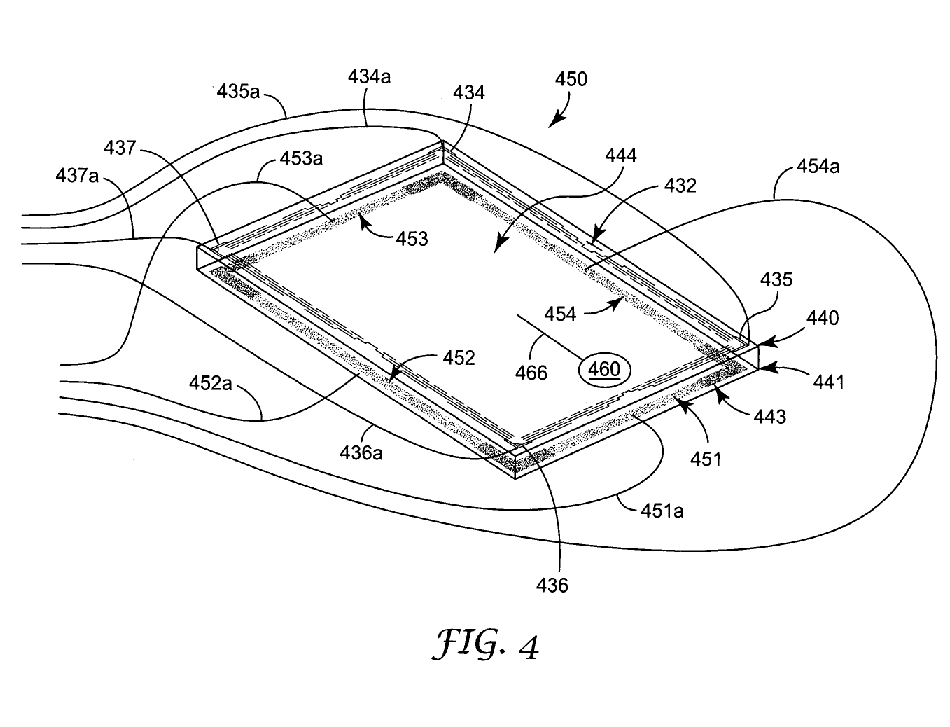

FIGS. 3 and 4 illustrate capacitive touch panels having rear electrodes used for error correction in accordance with embodiments of the invention. FIGS. 3 and 4 are examples of capacitive touch panels 330, 450 that do not include a transparent rear shield layer. The touch panels may include, for example, a single rear electrode 342 as depicted in FIG. 3, or multiple rear electrodes 451, 452, 453, 454, as depicted in FIG. 4. The rear electrodes 342, 451, 452, 453, 454 serve various purposes. For example, if connected to a low impedance, rear electrodes 342, 451, 452, 453, 454 shield a portion of the touch panel 330, 450 from EMI.

If driven with the same AC signal as the top resistive layer 344, 444 of the touch panel 330, 450, the rear electrodes 342, 451, 452, 453, 454, reduce capacitive coupling to conductive elements behind the touch panel 330, 450, typically including the display and/or chassis. If the rear electrodes 342, 451, 452, 453, 454 are driven with an equal or larger in-phase AC signal than the top resistive layer 344, 444 of the touch panel 330, 450, the net parasitic capacitive current through the touch panel 330, 450 can be offset to near zero level. This is most useful for large touch panels with high levels of parasitic capacitance that can reduce measurement sensitivity and/or exceed the drive capacity of amplifiers attached to the corners of the touch panels 330, 450. If driven with an AC signal, current flow to and from the rear electrode(s) 342, 451, 452, 453, 454 can be used to measure movement between the rear electrode(s) 342, 451, 452, 453, 454 of the touch panel 330, 450 and the conductive elements behind the touch panel 330, 450, such as the chassis or display. Additionally, the movement of the rear electrode(s) 342, 451, 452, 453, 454 may be used to measure the force applied to the touch panel 330, 450.

In FIG. 3, there is shown a capacitive touch panel in accordance with an embodiment of the present invention. According to this configuration, the touch panel 330 includes a linearization electrode pattern 332 connected to a top resistive layer 344 that is provided on a top surface 340 of the touch panel 330. The linearization electrode pattern 332 is configured to have a generally rectangular shape with four corner terminals 334, 335, 336, 337 respectively connected to a controller (not shown) via wires 334a, 335a, 336a, 337a. In normal operation, drive signals are applied to the corner terminals 334, 335, 336, 337 via respective drive circuits in the controller, and the controller measures currents flowing through the corner terminals 334, 335, 336, 337 via respective sense circuits in the controller. The currents flowing through the corner terminals 334, 335, 336, 337 are altered if the surface of the touch panel 344 is touched.

The corner terminals 334, 335, 336, 337 are typically driven with an AC voltage, and the linearization electrodes 332 distribute the voltage evenly across the top conductive layer 344. The touch panel 330 includes a single rear electrode 342 which, in this example, is configured as a band of conductive material disposed on a peripheral portion 343 of the rear surface 341 of the touch panel 330. In this configuration, the rear electrode 342 can be used as a partial shield below the linearization electrode pattern 332, which is a highly sensitive area of the touch screen sensor 330. The rear electrode 342 may be driven via wire 348 with an AC voltage equal to and in phase with the voltage driving corner terminals 334, 335, 336, 337. As such, the rear electrode 342 provides shielding against noise and also minimizes parasitic capacitance effects because negligible capacitive current flows from top resistive layer 344 to rear electrode 342.

Further, the rear electrode 342 may be used to measure movement of the touch panel 330 relative to nearby conductive structures. If the touch panel 330 flexes when touched, the capacitance between the rear electrode 342 and the display surface, chassis, or other supporting structure changes. The change in the signal at the rear electrode 342 is related to the amount of movement of the touch panel caused by touch force. The error signal at the rear electrode 342 may be used to correct for errors in the touch signals generated at the corner terminals 334, 335, 336, 337. The change in the signal at the rear electrode may also be used to measure touch force. The touch force measurement depends on the size of the touch panel 330, 450 and the mounting method.

With reference to FIG. 3, changes in the current in electrode 342 will be proportional to changes in capacitance between electrode 342 and the conductive surface behind the touch panel 330, such as a display (not shown). The change in capacitance is proportional to the relative movement of the touch panel 330 with respect to the display. The relative movement of the touch panel 330 is in turn proportional to the force on the touch panel 330, provided the touch panel 330 is movably mounted in proximity to a conductive surface.

Measured touch location errors may be reduced by modifying the measurements at corner terminals 334, 335, 336, 337 with the signal at rear electrode 342. For example, in one implementation, the change at rear electrode 342 may be subtracted equally from the signals at corner terminals 334, 335, 336, 337. In another implementation, the touch measurements may be discontinued during significant changes in the rear electrode 342 current to avoid errors in the signals caused by heavy touch pressure.

FIG. 4 illustrates another embodiment of a touch panel well suited for implementing the touch location processes of the present invention. FIG. 4 illustrates a capacitive touch panel 450 that does not include a rear shield. According to this embodiment, the touch panel 450 includes a linearization electrode pattern 432 connected to a top conductive layer 444 which is disposed on a top surface 440 of the touch panel 450. The linearization electrode 432 includes four corner terminals 434, 435, 436, 437 respectively connected to a controller (not shown) via wires 434a, 435a, 436a, 437a.

The rear electrode arrangement in the embodiment of FIG. 4 includes a number of discrete rear electrodes 451, 452, 453, 454 situated on the rear surface 441 of the touch panel 450. In the particular configuration shown in FIG. 4, four rear electrodes 451, 452, 453, 454 are located about the perimeter 443 of the rear surface 441, with each of the rear electrodes 451, 452, 453, 454 situated along one of the edge regions of the rear surface 441 of the touch panel 450. It is understood that the number and location of the rear electrodes 451, 452, 453, 454 can vary depending on a particular design.

In a configuration in which multiple rear electrodes are employed, as is the embodiment shown in FIG. 4, the controller (not shown) may drive the rear electrodes 451, 452, 453, 454 with an AC voltage equal to that applied at corner terminals 434, 435, 436, 437. When controlled in this manner, the multiple rear electrodes 451, 452, 453, 454 effectively perform the same function as the single rear electrode 342 in the embodiment depicted in FIG. 3.

The multiple rear electrodes 451, 452, 453, 454 are coupled to the controller via wires 451a, 452a, 453a, 454a. In addition to providing shielding for the touch panel 450, the rear electrodes 451, 452, 453, 454 may be used to detect and measure movement of the touch panel 450 relative to nearby conductive structures. If the touch panel 450 flexes or moves when touched, the capacitance between the rear electrodes 451, 452, 453, 454 and the display surface, chassis, or other supporting structure changes. The change in the signal at the rear electrodes 451, 452, 453, 454 is related to the amount of movement of the touch panel 450 relative to its supporting structures. The signals at the rear electrodes 451, 452, 453, 454 may be used to calculate the position of an applied force, and it may be used to correct errors in the touch signals generated at the corner terminals 434, 435, 436, 437. Equations 3 and 4 may be used to calculate the position, XD, YD, of an applied force that generates displacement of panel 450, where ΔT, ΔB, ΔL and ΔR are changes in signals in rear electrodes at the Top, Bottom, Left, and Right edges respectively of touch panel 450. Equation 5 may be used to calculate a change in total force applied to panel 450.
XD=(ΔR−ΔL)/(ΔR+ΔL) Equation 3
YD=(ΔT−ΔB)/(ΔT+ΔB) Equation 4
Z=ΔT+ΔB+ΔL+ΔR Equation 5

In one embodiment, touch location may be measured while displacement Z is less than a threshold amount, and subsequent changes in measured touch location may be ignored when touch force Z exceeds a preset threshold.

In another embodiment, a change in XT, YT accompanied by a proportional increase in Z may be interpreted as an error in XT, YT due to bending of panel 450. In response, the change in XT, YT may not be reported, or if the relationship between Z, XD, YD; and XT, YT changes are pre-measured and stored, then changes in Z, XD, YD may be translated into XT, YT error correction values that are then used to modify XT, YT to reduce errors. Alternatively, the relationship between Z, XD, YD and XT, YT errors may be calculated based on parameters of panel 450. Parameters include size and stiffness of panel 450, width of electrodes 451, 452, 453, 454, proximity of sensor 450 to grounded supporting members, and stiffness of the mounting system that attaches panel 450 to its supporting member(s).

In another embodiment, the touch position coordinates XT, YT calculated from measurements at corners 434, 435, 436, 437 (using Equations 1 and 2) may be modified by a second set of displacement-based coordinates XD, YD calculated with Equations 3 and 4. For example, given Z>a threshold value, measured changes in XT and YT are reported only if equal and simultaneous changes XD and YD are also measured. A change in XT, YT without a corresponding change in XD, YD is indicative of an error due to bending of panel 450.

In some embodiments, a calibration procedure may be used to help correlate the amount of movement to the magnitude of the error. For example, the calibration procedure may involve calculating the touch location at one or more calibration points using a varying amount of force to vary the bending and displacement of the touch panel. An exemplary calibration procedure may involve the following processes:
1. Touch very lightly, with Z˜0 at a point on the panel with known coordinates.
2. Measure corner currents and calculate touch location XT, YT and also XD, YD, and Z.
3. Gradually increase force at the touched point, thus increasing displacement and bending of the touch panel and determine the trend of XT, YT vs. XD, YD, Z for the point under test.
4. Store errors (ΔXT & ΔYT) vs. XD, YD, Z.
5. Subsequently, during normal operation, subtract known (ΔXT and ΔYT) errors caused by significant XD, YD, Z changes.

The calibration procedure may be performed at any number of calibration points on the touch panel. During normal operation, errors at touch locations between the calibration points may be interpolated. The amount of movement or flexing of a touch panel may be a function of the touch panel size and materials. Prior to installation, a universal calibration process may be performed for all similar touch panels. It may be beneficial to perform an additional calibration (or the initial calibration) after installation of the touch panel. Calibration of the touch panel after installation may account for the specific configuration, environmental factors, integration process of the touch panel installation, and/or other installation-related factors that can affect touch location accuracy.

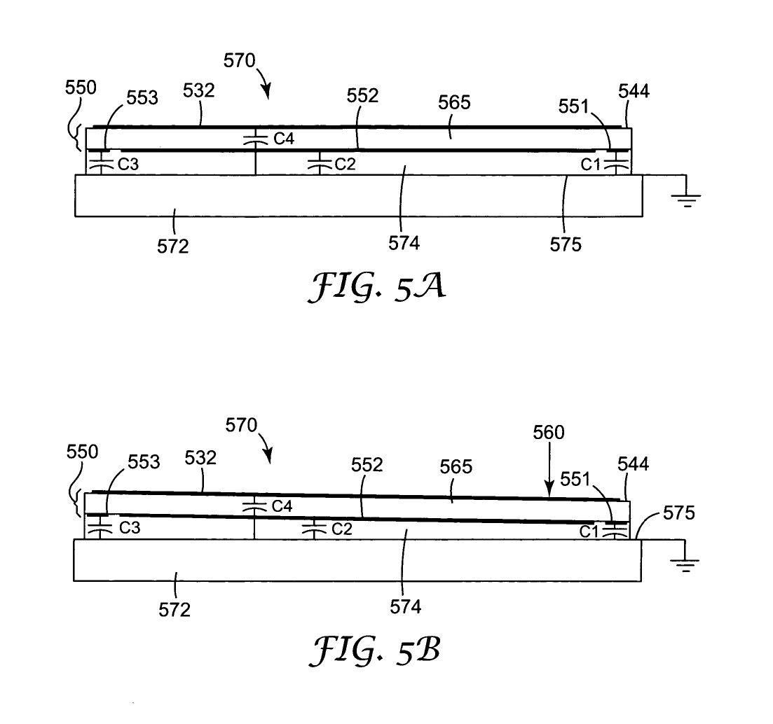

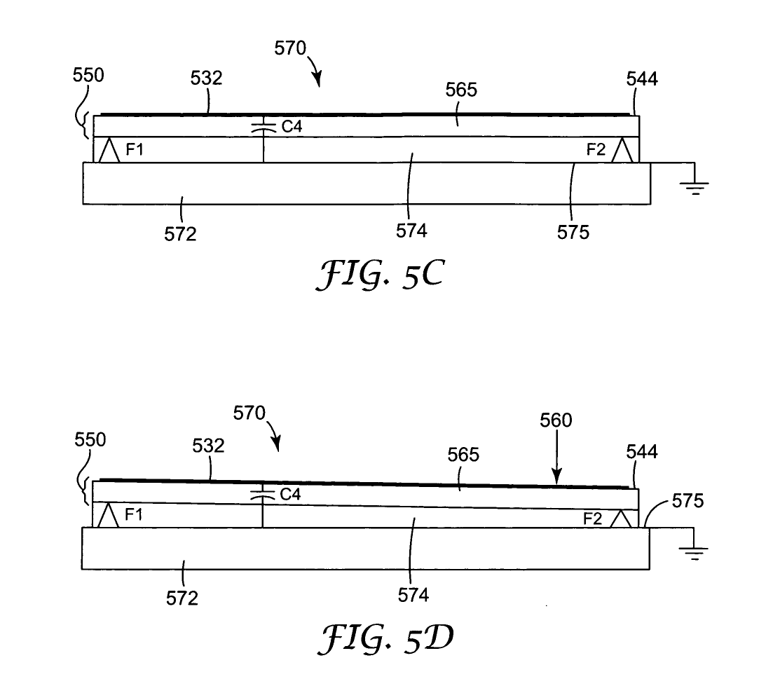

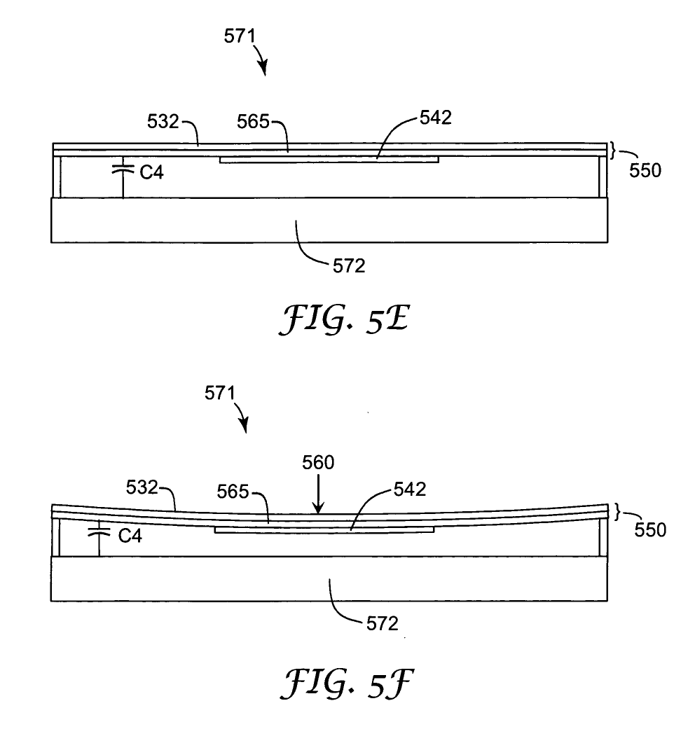

FIGS. 5A and 5B are diagrams illustrating cross sections of a touch system 570 employing a capacitive touch panel 550, compliant foam spacer 574, and display 572 in accordance with embodiments of the invention. The capacitive touch panel 550 includes a capacitive substrate 565 and a conductive layer 532. The conductive top surface 575 of the display 572 is connected to ground through a low impedance. Electrodes 551, 553, and 552 are equidistant from the top surface 575 of the display 572.

FIG. 5B illustrates the same system 570 after a touch force 560 is applied sufficient to cause the compliant foam 574 to compress on the right side of the touch system 570. The force of the touch and resultant compression of the foam 574 causes the electrode 551 to move closer to the conductive surface 575 than electrode 553. Given equal AC signals at the electrodes 551 and 553, the currents flowing to electrodes 551 and 553 are equal in FIG. 5A. However, for the system 570 as in FIG. 5B, the current in electrode 551 is greater than the current in electrode 553 by an amount proportional to the relative displacement of electrodes 551 and 553 resulting from the applied force 560. Force may be calculated from displacement, given the known displacement/force properties of compliant foam 574 and bending properties of panel 550. Thus the amount and approximate location of a touch force may be measured.

The capacitances between the touch panel 550 and the display 572 are represented by capacitors C1, C2, C3, C4. Capacitors C1, C2, and C3 represent the capacitance between electrodes 551, 552, 553 and the display surface 575. Capacitance C4 represents the capacitance between display surface 575 and the combination of the conductive surface 544 and layer 532. The touch location is determined by a change in capacitance between touch panel surface 544 and a touching finger (not shown). This change in capacitance may be measured as changes in current at corner electrodes. But, changes in capacitance C4 will also cause changes in capacitance measured at corner electrodes of surface 544, resulting in errors. Capacitive touch position errors can be reduced by modifying touch position measured via corner electrodes and Equations 1 and 2 with the displacement measured via electrodes 551-553 and Equations 3 and 4. For example, error correction may be accomplished by comparing the XT, YT coordinates with the XD, YD coordinates. If a change in XT and YT is the same as a change in XD and YD within a preset limit, then a new XT and YT are calculated and communicated to a host computer. If the XT, YT and XD, YD coordinates do not agree within a limit, new XT, YT coordinates are not calculated.

FIGS. 5C and 5D illustrate another configuration in accordance with an embodiment of the invention. In FIGS. 5C and 5D, the rear electrodes 551, 552, 553 of FIGS. 5A and 5B have been replaced by force/displacement sensors F1 and F2. The force/displacement sensors may be any type of force/displacement sensors, including, for example, piezoelectric sensors, strain gauge sensors, capacitive force sensors, or other sensor types. Force/displacement sensors may measure force/displacement between the rear surface of capacitive substrate 565 and display 572 as shown in FIGS. 5C and 5D, or they may measure force/displacement between the front surface of panel 565 and a front-mounted bezel (not shown). Measurement of force/displacement may be made between front-mounted bezel (not shown) and a front mounted shield described in commonly owned U.S. Pat. No. 5,457,289 which is incorporated herein by reference. FIGS. 5C and 5D illustrate the touch system before and after an applied touch 560, respectively. In FIG. 5C, the force on the force sensors F1 and F2 is approximately equal. In FIG. 5D, the force at sensor F2 is greater than the force at sensor F1 due to the applied touch 560, causing greater force and/or displacement at sensor F2 than at sensor F1. In this embodiment, error correction may be accomplished by measuring the touch signals, measuring the panel displacement or force using the force/displacement sensors and adjusting the touch position calculation of XT, YT to compensate for capacitance changes caused by displacement of panel 550.

In other embodiments, the touch panel may incorporate bending mode touch sensors. Bending mode sensors may measure bending between the rear surface of panel 565 and substrate 572 as shown in FIGS. 5C and 5D, or they may measure bending between the front surface of panel 565 and a front-mounted bezel (not shown). The signals generated by the bending mode sensors may be used to correct for parasitic capacitance changes due to touch pressure. Bending mode and/or other sensing methodologies may also be optionally used to provide Z-axis touch force measurement.

FIGS. 5E and 5F illustrate cross sections of a touch system 571 employing a capacitive touch panel 550 and display 572 and having one or more bending mode sensors 542 in accordance with embodiments of the invention. The touch panel 550 includes capacitive substrate 565 and conductive layer 532. In the illustrated implementation, the bending mode sensors 542 are disposed on each edge of the touch panel 550. In various configurations, the sensors 542 may extend along the full length of each edge of the touch panel 550, or a portion of the edge. FIGS. 5E and 5F illustrate the touch system before and after a touch 560, respectively. In FIG. 5E, there is no bending of the touch panel 550. In FIG. 5F, a touch 560 is applied to the touch panel 550. The touch 560 causes the touch panel 550 to bend and may also initiate low frequency oscillations of the touch panel 550. Touch panel bending and/or low frequency oscillations of the touch panel may be detected by bending mode sensors 542 and may be used to correct for errors due to touch panel displacement. Displacement and/or low frequency oscillations of the touch panel 550 may additionally or alternatively be used to calculate the Z-axis force exerted on the touch panel 550 by the touch 560.

In one implementation, the bending mode sensors 542 may be used to measure the displacement of the touch panel 550 from the untouched position as a result of the touch force 560. The displacement measured by the bending mode sensors 542 may be used to correct for errors in the capacitive touch location measurement. In this implementation, error correction may be accomplished by measuring the touch signals, measuring the panel movement using the bending mode sensors 542 and adjusting the touch position calculation of XT, YT to compensate for capacitance changes caused by displacement of panel 550.

In another implementation, the bending mode sensors 542 may be used to measure the low frequency oscillations caused by the touch 560. The fundamental half-wave frequency of oscillation of a typical glass touch panel is in the range of about 50 Hz to about 1000 Hz, depending on touch panel thickness, edge length, and suspension characteristics. Finger touches produce energy in the range of about 5 Hz to about 1000 Hz. Measuring bending mode signals in the frequency range of about 50 Hz to about 1000 Hz reduces the effects of hysteresis and/or non-linearity in the spring constant of the suspension relative to the near-static 0 to 10 Hz measurements.

In this embodiment, error correction may be accomplished by measuring the touch signals based on capacitive measurements and determining the panel displacement based on the low frequency oscillations of the panel as detected by the bending mode sensors 542. The touch position calculation of XT, YT may be adjusted using panel movement information acquired by the bending mode sensors 542 to compensate for capacitance changes caused by displacement of panel 550.

Referring to FIGS. 4 and 5A, brushing a finger lightly over the front of touch screen 450, touching down at point 460 and stroking toward the center of touch screen 450 would result in the measured line 466. A touch and simultaneous hard push against touch screen 450 at point 460 may also result in an initial measured touch point at point 460. Then, under increasing touch pressure, touch screen 450 will move closer to the display on which it is mounted, and substrate 465 will also bow inward toward its center. This will increase capacitances C4 and C1, which may erroneously result in an apparent shift in touch position along the same line 466. Thus, a stroking touch and a touch in one location may both be measured as a line. This error due to applied force may be reduced by one of several methods. First, initial touch location may be measured prior to application of significant force, and subsequent changes in measured touch location are ignored when touch force exceeds a preset threshold. Second, the touch position coordinates XT, YT calculated from measurements at corners 434, 435, 436, 437 (using Equations 1 and 2) may be modified by a second set of displacement coordinates XD, YD calculated from the change in force location as described herein.

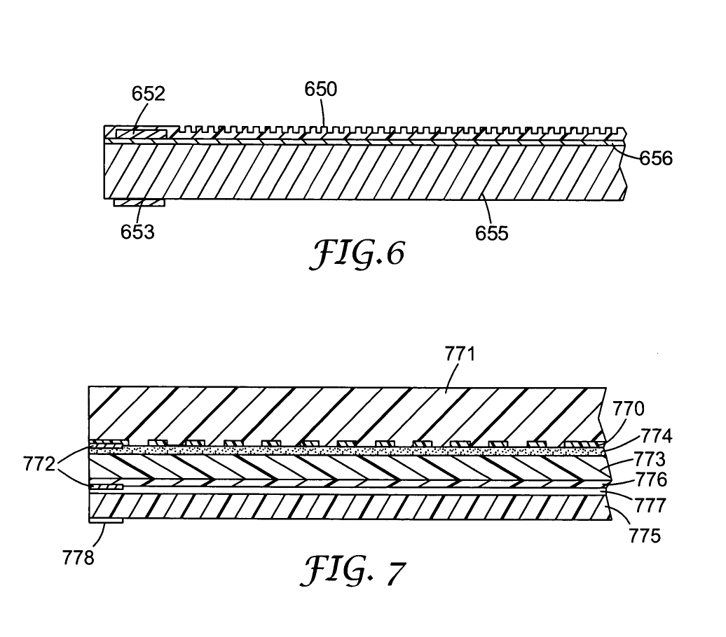

FIGS. 6-8 illustrate various types of capacitive touch panels that may utilize error correction processes as described herein. One embodiment of a capacitive touch panel is depicted in FIG. 6. The capacitive sensor shown in FIG. 6 includes a capacitive substrate 655 having a conductive coating 656 (e.g., tin-antimony-oxide (TAO)). An anti-glare surface 650 may be provided over (or under) the touch surface 656. Corner electrode 652 is disposed on the touch surface 656 and rear electrode 653 is disposed on the capacitive substrate 655.

The methods of the invention may also be applied to matrix touch sensors. Matrix sensors typically have a top array of parallel electrodes and a bottom array of parallel electrodes oriented 90° from the top array. A touch can be measured as a capacitive change in a few electrodes of both arrays. Larger objects such as a hand, arm, or body in proximity with a matrix sensor will be measured as a capacitive change in many electrodes of both arrays. The top array is closer to the finger, hand, or arm so it will generally have a larger response to movement of the proximate finger, or a hand or arm. The top and bottom electrode arrays have a fixed, known relationship so the relative magnitude of capacitive coupling to objects (e.g. a finger touch) near the front sensor surface can be used to discriminate these and to measure touch location. Likewise, the known relationship of top and bottom arrays may be used to discriminate and measure sensor movement relative to objects behind the touch sensor.

The bottom array is closer to conductive component(s) behind the sensor, so movement of the sensor will cause a greater signal change on many or all of the bottom electrodes. This difference in relative magnitude between top and bottom arrays may be used to discriminate between a touch or movement in front of the sensor, and a sensor movement caused by pressure on the sensor. For a matrix touch sensor, the relative change of the signals in rear electrodes vs. front electrodes may be measured and analyzed to discriminate between movement of a sensor relative to its mounting, and movement of objects in proximity to the front (touch) surface of a sensor.

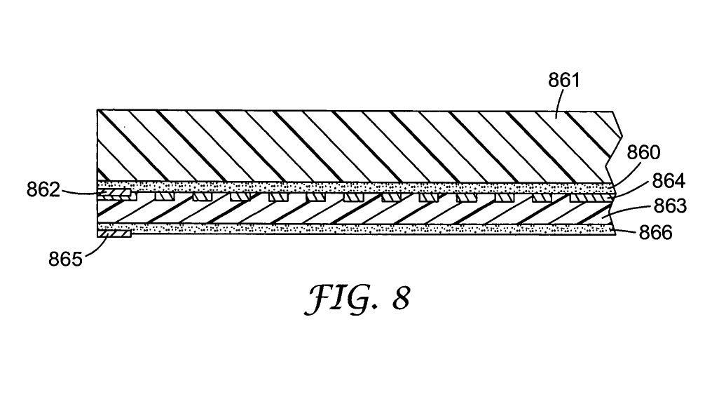

FIG. 7 illustrates an embodiment of a matrix capacitive touch panel, which is shown to include a matrix capacitive substrate 771. A first touch sensing surface (e.g., indium tin oxide (ITO)) 770 is disposed adjacent the grid capacitive substrate 771. Positioned adjacent the first touch surface 770 are first pressure sensitive adhesive (PSA) layer 774 followed by first conductive polyester or glass layer 773. A second touch sensing surface (e.g., ITO) 776 is situated adjacent the first conductive polyester or glass layer 773. Adjacent the second touch sensing surface 776 is a second PSA layer 777 and a second conductive polyester or glass layer 775. Touch sensing electrodes 772 are disposed on the touch sensitive surfaces 770, 776. An error sensing electrode 778 is disposed on the second conductive polyester or glass layer 775. Additional details of matrix capacitive touch screen sensors of the type depicted in FIG. 7 are disclosed in commonly owned U.S. Pat. Nos. 4,686,332 and 5,844,506, for example, which are hereby incorporated by reference.

An embodiment of a projective capacitive near field imaging (NFI) touch panel is depicted in FIG. 8. The NFI capacitive touch panel shown in FIG. 8 includes an NFI substrate 861 positioned above a first transparent pressure sensitive adhesive (PSA) layer 860. Conductive ITO bars 864 define the touch sensitive surface of the touch panel. A first conductive polyester layer (e.g., PET) 863 is disposed adjacent the touch sensitive surface 864. A second PSA layer 866 is disposed on the conductive polyester layer 863. A touch sensing electrode 862 is shown disposed on the touch sensitive surface 864. An error sensing electrode 865 is disposed on the PSA layer 866. Additional details of an NFI capacitive touch panel of the type depicted in FIG. 8 are disclosed in U.S. Pat. No. 5,650,597, and in commonly owned U.S. Pat. No. 6,825,833, U.S. patent application Ser. No. 10/176,564, and U.S. patent application Ser. No. 10/201,400, all of which are hereby incorporated herein by reference in their respective entireties.

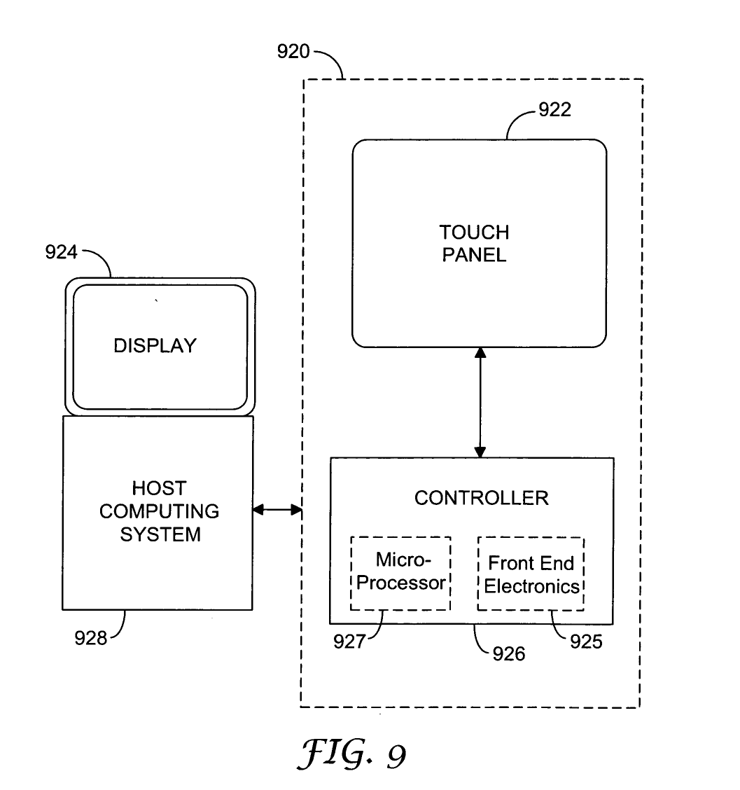

Turning now to FIG. 9, there is shown an embodiment of a touch screen system that is suitable for implementing enhanced touch location determination in accordance with an embodiment of the present invention. The touch system 920 shown in FIG. 9 includes a touch panel 922, which is communicatively coupled to a controller 926. The controller 926 includes at least electronic circuitry 925 (e.g., front end electronics) that applies signals to the touch panel 922 and measures touch signals or touch signal changes and error signals or error signal changes. In more robust configurations, the controller 926 can further include a microprocessor 927 in addition to front end electronics 925. In a typical deployment configuration, the touch panel 922 is used in combination with a display 924 of a host computing system 928 to provide for visual and tactile interaction between a user and the host computing system 928.

It is understood that the touch panel 922 can be implemented as a device separate from, but operative with, a display 924 of the host computing system 928. Alternatively, the touch panel 922 can be implemented as part of a unitary system that includes a display device, such as a plasma, LCD, or other type of display technology amenable to incorporation of the touch panel 922. It is further understood that utility is found in a system defined to include only the sensor 922 and controller 926 which, together, can implement touch detection methodologies of the present invention.

In the illustrative configuration shown in FIG. 9, communication between the touch panel 922 and the host computing system 928 is effected via the controller 926. It is noted that one or more controllers 926 can be communicatively coupled to one or more touch panels 922 and the host computing system 928. The controller 926 is typically configured to execute firmware/software that provides for detection of touches applied to the touch panel 922, including error correction for movement of the touch panel in accordance with the principles of the present invention. It is understood that the functions and routines executed by the controller 926 can alternatively be effected by a processor or controller of the host computing system 928.

The methods of movement and/or force measurement described herein may not be sufficiently accurate to locate a touch position independently. However, the processes are sufficiently accurate to allow correction of capacitive touch measurement errors that are caused by movement due to force. Further, the accuracy of the movement and/or force measurements may be sufficient to yield useful touch pressure and displacement (Z-axis) measurements. Inaccuracies in force measurements may result from the non-linear spring constant and hysteresis in the spring action of typical foam suspension materials. Bending of the panel under touch pressure, and also flexure of display may cause additional errors.

Touch location processes may be enhanced by removing errors due to movement of a capacitive touch panel relative to surrounding conductive structures. Embodiments of the present invention advantageously use a capacitive touch panel without a rear shield. The rear shield layer may be removed to improved optics and cost, and the techniques described herein may be use to maintain the touch location accuracy. Rear electrodes can provide limited EMI shielding in lieu of a transparent rear shield layer. Driven rear electrodes can reduce currents due to parasitic capacitance. Further, rear electrode signal changes may be used to measure and report Z-axis force on the touch panel.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A touch sensitive device, comprising:
a capacitive touch sensor configured to generate signals indicative of a location of a capacitively coupled touch on a touch surface;
an error correction sensor configured to generate a signal associated with an error in the touch location signals, the error associated with movement of the capacitive touch sensor; and
a processor configured to determine the touch location based on the touch location signals and the error signal.

2. The device of claim 1, wherein the error correction sensor comprises a capacitive sensor.

3. The device of claim 1, wherein the error correction sensor comprises a force sensor.

4. The device of claim 1, wherein the error correction sensor comprises a bending wave sensor.

5. The device of claim 1, where the error correction sensor is further configured to sense a force of the touch on the touch surface.

6. The device of claim 1, further comprising a display visible through the touch surface.

7. The device of claim 1, wherein:
the capacitive touch sensor comprises an electrode layer disposed on one side of a substrate; and
the error correction sensor comprises one or more electrodes disposed on an opposite side of the substrate.

8. The device of claim 7, wherein the one or more electrodes comprise a continuous electrode disposed on a peripheral portion of the substrate.

9. The device of claim 7, wherein the one or more electrodes comprise a plurality of discrete electrodes disposed on a peripheral portion of the substrate.

10. The device of claim 7, wherein the electrode layer is driven with an AC signal.

11. The device of claim 7, wherein the one or more electrodes are driven with an AC signal.

12. The device of claim 7, wherein the one or more electrodes are configured to shield portions of the electrode layer from EMI.

13. The device of claim 7, wherein the one or more electrodes are configured to reduce capacitive coupling between the electrode layer and conductive structures of the touch sensitive device.

14. A method for determining a location of a touch on a touch surface; comprising:
generating touch signals from a capacitively coupled touch on the touch surface;
generating an error signal associated with an error in the touch signals, the error associated with movement of the touch surface; and
determining the touch location based on the touch signals and the error signal.

15. The method of claim 14, wherein generating the error signal comprises measuring a change in capacitance responsive to movement of a touch sensor used to generate the touch signals.

16. The method of claim 14, wherein determining the touch location comprises adjusting the touch signals based on the error signal.

17. The method of claim 14, further comprising measuring a touch force using the error signal.

18. The method of claim 14, further comprising calibrating the touch surface using the error signal.

19. A touch sensitive device, comprising:
means for generating touch signals associated with a change in capacitance responsive to the touch on the touch surface;
means for generating an error signal associated with an error in the touch signals; and
means for determining the touch location based on the touch signals and the error signal.

20. The touch sensitive device of claim 19, further comprising means for measuring a touch force using the error signal.
